(19) United States
(12) Patent Application Publication
(10) Pub. No.: US 2012/0093467 A1
(43) Pub. Date: Apr. 19, 2012

(54) Actuation Feature For Fiber Optic Connectors In Dense Arrays

(75) Inventors: Robert K. Mullady, Highland, NY (US); Alan F. Benner, Poughkeepsie, NY (US)

(73) Assignee: INTERNATIONAL BUSINESS MACHINES CORPORATION, Armonk, NY (US)

(21) Appl. No.: 12/904,195

(22) Filed: Oct. 14, 2010

(51) Int. Cl. G02B 6/36; G02B 6/46

(52) U.S. Cl. 385/89; 29/525.03

(57) ABSTRACT

An apparatus and related method is provided for connecting fiber optic cables to devices. In one embodiment, the apparatus comprises an optical fiber connector enabled to receive a cable containing one or a bundle of optical fibers. An actuation sleeve with extendable features is disposed on opposing sides of the connector. The apparatus also includes an actuation sheath engageable with the connector with sleeve(s) and cable(s). The actuation sheath has a plurality of side members connected to one another by a handle area such that the handle area can be used to engage and disengage the actuation sheath with cable and connector as a single unit from the device.

### BACKGROUND OF THE INVENTION

1. Field of the Invention

This invention relates to fiber optic connectors and more particularly to an optimized fiber optic connector used where greater density of connection is desired.

2. Description of Background

Optical fibers have become the preferred medium for data processing in telecommunication and networking industries for a number of reasons. For one, fibers are flexible and can be bundled as cables. In addition, use of fiber optics is especially advantageous when utilized for long distance communication and related applications since fibers permit data transmission over longer distances at higher bandwidths and data rates. Use of optical fibers over metal wires is preferable because optical fibers enable signals to travel along them with little loss and with minimal electromagnetic interference. For short distance applications, use of fiber optic cabling leads to more efficient use of office footprint because a single fiber can often carry much more data than many electrical cables.

An optical fiber is often a cylindrical shaped dielectric waveguide that transmits light along its axis through total internal reflection. The fiber consists of a core that is surrounded by a cladding layer, both of which are made from dielectric materials. The core carries the light pulses which the cladding allows for the reflecting of the light pulses back in to the core. The core and the cladding are then often protected by a layer of buffer coating to protect them from moisture or other forms of damages. The ends of the fibers must be carefully cleaved and then spliced together either mechanically or by fusing them together such as with an electric arc. Consequently, due to the structure of a fiber optic cable making fiber connections more complex than electrical wire or cable connections and often even require special connectors to enable removable connections.

In addition to the complexity of connections, density of required connections pose another challenge in the use of fiber optic connections. The popular use of fiber optic cables and the need for specialized connectors have led in recent years to overcrowding in connection areas. The advent of technology and the popular use of fiber optics have created need for arrays of densely populated connectors and cable in a given area in many devices that are not always easy to handle.

Access to fiber optic connectors in these dense array areas is difficult due to limited room for fingers or other tools that require just as much room. In computing environments, especially those that entail complex designs and sophisticated high connectivity devices, the greater density of connection required can lead to crucial accessibility issues that if not addressed properly will create critical performance problems.

Consequently, an improved system and related methods of actuation is required in connection with use of fiber optic connectors and cable especially in dense connection areas. A desirable method and system provides easy actuation and access such that the cables connector combinations can engage and disengage with one another and/or to other devices with precision.

### SUMMARY OF THE INVENTION

The shortcomings of the prior art are overcome and additional advantages are provided through an apparatus and related method that is provided for connecting fiber optic cables to devices. In one embodiment, the apparatus comprises a fiber optics connector enabled to receive a cable containing one or even a bundle of optical fibers. An actuation sleeve with extendable features is disposed on opposing sides of the connector. The apparatus also includes an actuation sheath engageable with the connector with sleeve(s) and cable(s). The actuation sheath has a plurality of side members connected to one another by a handle area such that the handle area can be used to engage and disengage the actuation sheath with cable and connector as a single unit from the device.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an isometric diagram of a fiber optic array arrangement having a plurality of fiber optic connectors in accordance with one embodiment of the present invention;

FIG. 2 is an isometric diagram of a partially assembled connector apparatus as per one embodiment of the present invention showing a plug connector;

FIG. 3 is another isometric diagram of a partially assembled connector apparatus as per one embodiment of the present invention and having an actuation sheath;

FIG. 4 is an isometric diagram of a fiber optic array arrangement having a plurality actuation sheaths with a plurality of lengths and arranged according to length selectively.

### DESCRIPTION OF THE INVENTION

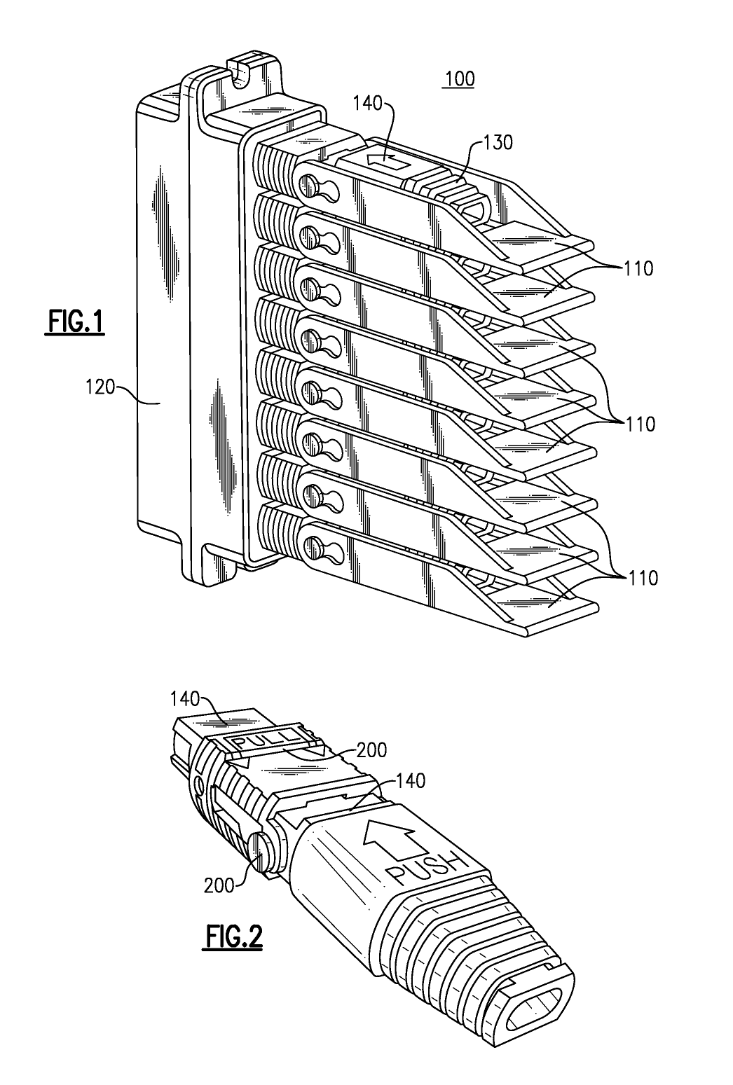

Referring to drawings, FIG. 1 shows an isometric diagram of a fiber optic array arrangement 100 made in accordance with one embodiment of the present invention. The illustration of FIG. 1 shows an example where a plurality of apparatus 110 are shown connecting a device 120 to fiber optic cables and connectors. The device 120 can be a single area of one device or act as a general connector that can attach a plurality of devices to one another. Alternatively, a similar arrangement can be used to connect the fiber optic fibers/cables to one another. However, for ease of discussion device connection will be discussed herein alone with the understanding that cable to cable connections can be accomplished using similar means as appreciated by those skilled in the art. In addition, the arrangement as shown in FIG. 1 may be different in that the connections/cables are provided horizontally or at an angle or even be part of a more densely arranged array having vertical and horizontal rows. The present arrangement as shown is provided for ease of understanding.

In one embodiment, each apparatus 110 is enabled to receive one cable containing one fiber or a bundle of optical fibers along with their connector assemblies as desired. In the case of FIG. 1, as per example a plurality of cables carrying fibers are shown, with a strain relief boot surrounding the end of each, as referenced by numerals 130. The cable assembly also includes a connector for optical fibers and is referenced as 140. As known to those skilled in the art, other similar connectors can be used in alternate embodiments. The connector 140 is to be ultimately engaged with the device connector 120.

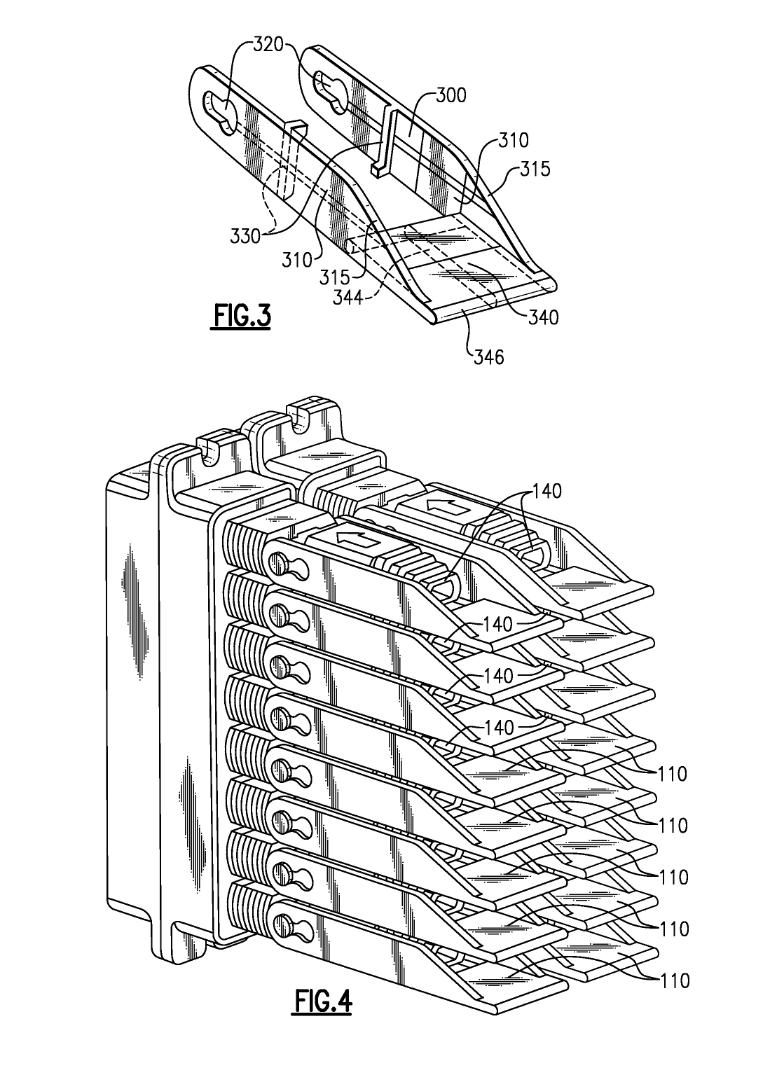

FIGS. 2 and 3 provide isometric diagrams of the apparatus 110 in more detail. In both figures, like elements are provided with like reference numbers. FIGS. 2 and 3 are both partially assembled drawing of the apparatus 110 as discussed in conjunction with FIG. 1.

In FIG. 2, the connector 140 of FIG. 1 is illustrated with an actuation sleeve 200 disposed around it. The actuation sleeve 200 is to be engaged with an actuation sheath 300 as will be later discussed in connection with FIG. 3. In this example, the actuation sleeve 200 incorporates two extendable features that are disposed around or alternatively are added to the opposing sides of the connector 140 to enhance security of connection with the actuation sheath (300).

In one embodiment as shown in FIG. 2, the actuation sleeve's 200 extendable features are secured to the sleeve on opposing sides of the connector 140 as shown. In this embodiment, the actuation sleeve 200 (and its features) can be secured to the plug 140 in a number of ways as appreciated by those skilled in the art, including but not limited to use of adhesives, screws, pins, tongue and grooves and other similar structures such as those that contain spring loaded features or even as a single unit connecting the two side features by a connecting piece that slides around the connector 140.

In the embodiment shown, the extendable feature has a mushroom like or knob like structure comprising of an outer and an inner component. The inner component which will directly be disposed adjacent to the connector 140 is narrower in diameter such that when engaged with a complementary keyhole receiving part, the narrower component slides into the keyhole and the wider component prevents movement and thus locks the feature in place. Such a keyhole arrangement is provided as part of the receiving area of actuation sheath 300 as will be discussed later in conjunction with FIG. 3. In these embodiments, the inner and outer components are substantially circular. Other designs can also be used for the extendable feature, but such design will be complementary with the receiving area of actuation sheath 300 such that the two parts mate securely together and form a locking mechanism as known to those skilled in the art.

FIG. 3 shows an isometric diagram of a partially assembled apparatus 110 as discussed in connection with FIG. 1. As per one embodiment of the present invention, an actuation sheath 300 is also provided. The actuation sheath 300 is engageable with the connector 140 and sleeves 200. In one embodiment, the actuation sheath 300 has a plurality of opposing side members 310 connected to one another by a handle area 340.

The side members 310 and handle area 340 form together a receiving area, which appears as a central opening in this embodiment, for receiving the connector/cable strain relief boot assembly 140/130 as shown previously in FIG. 1 such that that the connector and cable combination together remain open on one side when received by said actuation sheath 300. The cable and connector combination are partially surrounded, in this embodiment on all other sides, by the actuation sheath 300 either by its sides members 310 or by its handle area 340. This is so that the connector 140 can easily mate or connect with the device 120 as was shown and discussed in connection with FIG. 1.

In one embodiment, the actuation sheath 300 includes receiving areas 320 on its sides 310 for securely engaging with the actuation sleeve 200 as discussed in FIG. 2. The shape of the receiving areas 320, as discussed, are complementary with the extension features of the sleeve 200 of FIG. 2. In one embodiment as shown these receiving areas can be keyhole slots such as to receive and mate with the actuation sleeve 200 as was discussed previously, especially in the case where the sleeve had mushroom or knob shaped structures with circular components. The receiving areas 320 are designed as to easily engage and disengage with the extendable features of the actuation sleeve 200 of FIG. 2 such that, in this embodiment, the actuation sheath 300 grips said connects securely on its opposing sides 310 to the actuation sleeve 200.

The receiving area 320 can be disposed anywhere along the side members 310. In this embodiment, the areas 320 are distanced from the handle area 340 to provide ease of access to the handle area. In other embodiments, it is possible to change the location of areas 320 and features 200 so that they are disposed on other sides/areas and to even dispose them asymmetrically. It is also possible to use more than two or even a single actuation sleeve/area and a single complementary extendable feature.

In one embodiment, lockable features are included in the receiving areas 320 or the extendable features (or together as an engaged unit) such that as to ensure a secure fit as known to those skilled in the art. However, the keyhole slot design provided in this embodiment is also designed to work as a form of lock that limits action of the sleeve/feature.

The handle area 340 of the actuation sheath 300 can also include an engage/disengage tab or grip area 346 used for engaging and disengaging the apparatus 110 including connector 140 with sleeve and cable strain relief boot 130 as a single unit together such as by simple pushing and pulling action. The handle area 340 can also include another area used for labeling shown by numerals 344. In one embodiment of the present invention, the side members 310 have a tapered end at the handle area 340 end to allow for better visibility of the labeling area and for better access to the (pull) grip area 346. The tapered ends are shown and referenced by numerals 315. The tapering at the ends can be selectively enlarged or narrowed, or disposed asymmetrically (or symmetrically) to enable access and as per other desired applications.

In the embodiment of FIG. 3, the labeling area 344 is substantially flat and shown to be relatively horizontal. This is not a requirement, however, as appreciated by those skilled in the art, and this arrangement can be varied. For example, a labeling area can be substantially vertical, placed at an angle or be even pivot-able or slide-able (in or out as well as up and down) or arranged in other ways such that the labeling area can move from a first to a second position to enable better access and viewing as desired.

Similarly, while the gripping area 346 is shown to be a slightly rounded edge of the handle area 340 and is substantially horizontal, again as appreciated by those skilled in the art, this is not a requirement. The grip area 346, can be provided vertically, at an angle, pivot-able, slide-able or even include a pull tab or other design that moves or extends in and out the area and/or from a first position to a second position selectively, again to enable the engaging and disengaging movement of the sheath and the gripping action in a way that optimizes maximum access as per different applications.

In some embodiments of the present invention, the actuation sheath 300 may be designed in a variety of sizes. In such an embodiment, sheaths of different sizes may be used in conjunction with one another in a manner as to make accessing them easier when stacked in a horizontal or vertical row. Alternatively, the length of the handle of the sheath can be varied accordingly. For example, in an array arrangement, the actuation sheaths on the upper level may be shorter than on lower levels of the array to this end. In other embodiments, the sheaths that are arranged in an array may be of graduated length so that each one is slightly longer or shorter than the one adjacent or on their immediate top or bottom rows, again as a means to ease access. An example of this is provided in the illustration of FIG. 4.

FIG. 4 is an isometric diagram of a fiber optic array arrangement having a plurality of fiber optic connector and cable combination received by a plurality of actuation sheaths of different handle lengths arranged according to length selectively.

Referring back to FIG. 3, the placement and location of the sheath 300 including the location and shape of its handle 340 having the grip area 346 and label area 344, however, has to be such that enables the handle/grip area to be used in a way that allows the actuation sheath 300 to be removed or alternatively inserted with cable, connector and actuation sleeve remaining as a single connected unit when the actuation sheath, connector with actuation sleeve and cable are securely engaged with one another.

In one embodiment of the present invention, retention features are also provided on inner side members 310 of the sheath 300. The retention features are referenced by numerals 330 as shown. The retention features 330, can but do not need to, be of the same dimensions or be disposed in exactly symmetrical positions on opposing side members 310. In fact, in the embodiment shown in FIG. 3, the retention features 330 are disposed on inner portion of opposing side members 310 but in different locations such that they do not directly face one another. This is to enable the actuation sheath 300 to be removed and/or be inserted with the connector, sleeve and cable combination into the device while minimizing stress and rotational forces on any one connection component in a way that may damage them.

Looking back at FIG.1, it is more obviousness that each retention feature 330 is disposed such as to grip either the cable strain relief boot 130 tightly (so that it cannot bend and move) during the engagement/disengagement movement or perform the same function with respect to the connector 140. The retention features 330 can be adjustable or be selectively designed as to provide a secure grip with the cable strain relief boot 130 and/or with the connector 140. This is helpful particularly in cases where the cable strain relief boots 130, as shown, have a tapered structure. In the latter case, while a distal end of the cable may be securely disposed inside the actuation sheath 300 and against the connector 140, the opposing proximal end of the cable facing the sheath's handle area 340 may be subject to movement because of its tapered structure, especially during the engagement and disengagement of the apparatus 110 due to rotational, stress and tensile forces.

It should also be noted that in different embodiments, the shape of the retention features 330 can vary from one another or be selectively chosen to fit a particular application. For example, in the figures shown, the top portion of the retention feature are narrower than the bottom portion such as to provide for the rotational, stress and tensile forces in or other directions and/or to cater to the particular arrangement of the cable(s) structure. However, as appreciated by those skilled in the art, other arrangements are also possible in alternate embodiments.

The actuation sheath 300 can be manufactured of a number of materials including plastics, metals or a combination of them. In addition, as known to those skilled in the art, the actuation sheath 300 can be fabricated either as a single unitary unit or as a plurality of units. For example the side members 310 and the handle area 340 can be fabricated as individual units and then assembled together or be of a single manufactured unit.

In addition the receiving area, which in this embodiment includes the central opening, can be made larger or smaller by varying the angle and attachment of the side members 310 to the handle area 340. This latter may be achieved by selectively fabricating the sheath's 300 dimensions as per a desired application or by allowing the sides members 310 and the handle area 340 individually or both to engage or disengage with one another in a way that makes the central area larger or smaller. For example, in one instance fasteners can be provided to allow one or both sides members 310 to get closer or further from one another by sliding or moving against the handle area 340 that is connecting them. In another example, the labeling area 346 can move from a first to a second position to make the central opening area longer or shorter as desired. As known to those skilled in the art, other arrangements or a combination of arrangements can be used to achieve alternate embodiments as desired.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An apparatus for connecting fiber optic cables to devices, comprising:
a fiber optic connector enabled to receive one cable containing one or more optical fibers;
an actuation sleeve having extendable features disposable on opposing sides of said connector; and
an actuation sheath engageable with said connector with sleeve and cable(s) combination; said actuation sheath receiving said cable and connector combination inside an area formed by a plurality of said actuation sheath's opposing side members connected to one another by a handle area, such that said actuation sheath's handle area can be used to engage and disengage said actuation sheath with cable and connector combination together from said device.

2. The apparatus of claim 1, wherein said actuation sheath further includes receiving areas on opposing side members for engaging and disengaging with said extendable features of said actuation sleeve such that said actuation sheath grips said connector securely on its opposing sides.

3. The apparatus of claim 2, wherein said extendable features and said receiving areas have complementary features to enable a secure fit.

4. The apparatus of claim 2, wherein said receiving areas have lockable features that locks said areas with said extendable features once engaged securely.

5. The apparatus of claim 2, wherein said receiving areas comprise keyhole slots.

6. The apparatus of claim 2, wherein said extendable features have a first inner and a second outer component, said inner component being narrower in diameter than said outer component and said inner component being attached to said connector.

7. The apparatus of claim 6, wherein said inner and outer components area circular.

8. The apparatus of claim 7, wherein said receiving areas comprise keyhole slots such that said inner component can slide easily into the slot and said outer component enables said feature and slot to remain lockably engaged.

9. The apparatus of claim 1, wherein said handle area further includes a labeling area.

10. The apparatus of claim 1, wherein said handle area further includes a grip area.

11. The apparatus of claim 10, wherein said handle area further includes a labeling area.

12. The apparatus of claim 11, wherein said labeling area is substantially flat and horizontal.

13. The apparatus of claim 11, wherein said labeling area can be moved from a first to a second position to ease access and labeling.

14. The apparatus of claim 10, wherein said grip area is substantially horizontal.

15. The apparatus of claim 14, wherein said grip area can be moved from a first to a second position to enable ease of access and engagement/disengagement of said sheath.

16. The apparatus of claim 1, wherein said area formed by said side members and said handle area in said actuation sheath and used for receiving said cable and connector combination, can be made larger or smaller by moving said side members, handle area or both from a first to a second position each.

17. The apparatus of claim 1, wherein said side members have a distal end facing said connector and cable and a proximal end facing said handle area and said proximal ends of said side members have tapered ends.

18. The apparatus of claim 1, wherein said side members have inner retention features disposed such as to provide a secure fit against said cable and connector and each disposed against said cable and connector respectively such as to minimize stress and/or rotational and tensile forces exerted during engagement or disengagement of said actuation sheath and cable and connector combination from said device.

19. A method of connecting fiber optic cables to devices, comprising:
disposing an actuation sleeve having extendable features around a fiber optic connector; and
engaging an fiber optics connector with one or a bundle of optical fibers with said connector and actuation sleeve;
receiving said cable and connector combination by an actuation sheath in an area of said sheath formed by said actuation sheath's opposing side members connected to one another by a handle area, such that said side members and handle area of said actuation sheath surround said cable and connector combination at least partially;
engaging and disengaging said cable and connector combination and said actuation sheath together as a single unit to/from one or more devices using said handle area of said actuation sheath.

20. A method of connecting fiber optic cables to devices, comprising:
disposing a plurality of actuation sleeves having extendable features around a plurality of fiber optic connectors engaged with one or bundles of fiber optics cables;
engaging a plurality of actuations sheaths with each set of connector and cable combination such that said actuation sheaths receive said cable and connector combination in a central opening formed by said actuation sheath's opposing side members connected together by a handle area; said handle area of said plurality of actuation sheaths being of varying lengths;
arranging said actuation sheaths and cable and connector combination based on length of said actuation sheath handles such that said actuation sheath with said cable and connector combination can be engaged and disengaged as a single unit with a plurality of device or device connectors arranged in an array.
